(19) United States
(12) Patent Application Publication
(10) Pub. No.: US 2008/0125103 A1
(43) Pub. Date: May 29, 2008

(54) PRIORITIZING AND PRESENTING SERVICE OFFERINGS WITHIN A MOBILE DEVICE BASED UPON A DATA DRIVEN USER CONTEXT

(75) Inventor: VON A. MOCK, BOYNTON BEACH, FL (US)

Correspondence Address: PATENTS ON DEMAND, P.A., 4581 WESTON ROAD, SUITE 345, WESTON, FL, 33331, US

(73) Assignee: MOTOROLA, INC., SCHAUMBURG, IL (US)

(21) Appl. No.: 11/673,350

(22) Filed: Feb. 9, 2007

Related U.S. Application Data
(60) Provisional application No. 60/867,343, filed on Nov. 27, 2006.

(51) Int. Cl. H04M 3/42

(52) U.S. Cl. 455/418

(57) ABSTRACT

A method for dynamically selecting user presented services that are based upon a situation context. The method can include a mobile communication device that can identify situational data. Situational data can include items such as the device location, a user profile, and additional data elements. Next the situation context can be determined from the situational data. Based on the situation context, a set of services can be prioritized for the situation. A portion of the set of services can be dynamically presented on an interlace of the mobile device. A user selection of a presented service can be received via the interface. In response to the user selection, a programmatic action can be performed, such as contacting the service provider associated with the selected service.

### CROSS-REFERENCE TO RELATED APPLICATIONS

The present application claims the benefit of U.S. Provisional Application No. 60/867,343 filed Nov. 27, 2006, which is hereby incorporated by reference herein.

### BACKGROUND

1. Field of the Invention

The present invention relates to mobile telecommunications and, more particularly, to prioritizing and presenting service offerings within a mobile device based upon a data driven user context.

2. Description of the Related Art

Mobile communication devices are quickly becoming an essential tool of the information age. A mobile device user generally has immediate access to telephony and Web-based resources that places users within easy reach of a vast array of user-selectable services. These available services can include information services, such as weather services, news services, traffic services, sports reporting services, movie and television listing services, and the like. A user can also have access to e-commerce services, such as online shopping services, product review services, local store inventories and specials, and similar offerings. Other types of available services can include entertainment services, business services, emergency services, research services, communication services, and customer support services, just to name a few,

The abundance of available services often results in data overload. A user is inundated with a quantity of possible services that it exceeds a cognitive threshold of usability. Basically, the amount of time required for a user to find a desired service, if one exists, if often perceived as being more burdensome than doing without the service. For example, the prospect of having to search through a multitude of store product pages to find a desired item often deters a user from using what can be a valuable and time-saving service.

What is needed is a solution that dynamically presents a listing of available services within a mobile device interface that corresponds to a user's needs. Ideally, the listing would dynamically change as the user's needs and/or situation changes. For example, the listing would change to reflect different available services as the user travels to their destination.

### SUMMARY OF THE INVENTION

The present solution determines a data-driven context for a mobile device user based upon location and available data. Available services can be prioritized based upon the determined context. If a context represents a condition that a user may not be aware of an alert or notification can be presented to the user along with the top N ones of the prioritized services. A value of N can be configured. A user can select any of these services, which results in the service being initialized. The selection and initialization of a service can occur through many different mechanisms, such as through a push-to-talk. (PTT) or push-to-experience (PTE) capability, through a Web interface, through a voice response interface, and the like. In one embodiment, when a service is selected, available data associated with the current situation that is determined to be of use to a service provider can be automatically provided to alleviate a manual entry need.

To illustrate the solution by an example, a mobile communication device of a driver can be communicatively linked to an in-vehicle computing system, a calendaring system, and can have access to a location memory store containing driver-specific information. The vehicle can unexpectedly stop at an unscheduled location for an extended duration. In-vehicle gauges can indicate a vehicle malfunction. The mobile device can automatically determine that a situational context for the driver is associated with a vehicle problem. A list of vehicle repair and breakdown-related services can be granted high priority in this context. The user can be automatically presented with a list of services, such as towing, scheduling a repair with a mechanic, reserving a rental car, and the like. Previous user history and preferences, service costs, expected service times, and other such factors can be accounted for when the services are prioritized to anticipate the user's needs.

The present invention can be implemented in accordance with numerous aspects consistent with material presented herein. For example, one aspect of the present invention can include a method for dynamically selecting user presented services that are based upon a situation context. The method can include a mobile communication device that can identify situational data. Situational data can include items such as the device location, a user profile, and additional data elements. Next the situation context can be determined from the situational data. Based on the situation context, a set of services can be prioritized for the situation. At least a portion of the ordered set of services can be dynamically presented on an interface of the mobile device. For example, a set of the top ten services can be presented, where the number of presented services can be a user configurable or a device configurable value. A user selection of a presented service can be received via the interface. In response to the user selection, a programmatic action can be performed, such as contacting the service provider associated with the selected service.

Another aspect of the present invention can include a mobile communication device. The mobile communication device can include the following components: a location detection component, a transceiver, a memory store containing user-specific information, a context processor, a prioritization engine, a user interlace, and a service processor. The location detection component can be configured to automatically determine the location of the mobile communication device. Data exchanges can be conducted with a remotely located data store via the transceiver. The context processor can be configured to dynamically and automatically determine a situational context based upon available information, such as device location and user-specific information. The prioritization engine can be configured to automatically prioritize a set of available services based upon the determined situational context. Prioritized items of the set of available services can be presented in the user interface for user selection. The service processor can be configured to handle the execution of a user selected service.

Still another aspect of the present invention can include a method for situationaly prioritizing services for display on a mobile communication device. The method can begin with the location of a mobile communication device being automatically and dynamically determined. Data relating to the subscriber or location can then be acquired from multiple sources. A list of available services can be prioritized based upon the acquired data and location. The prioritized list of services can be presented within an interlace of the mobile device. The steps of the method can be iteratively repeated, which can cause the entries of the prioritized list to dynamically change as the acquired data or the determined location changes.

It should be noted that various aspects of the invention can be implemented as a program for controlling computing equipment to implement the functions described herein, or a program for enabling computing equipment to perform processes corresponding to the steps disclosed herein. This program may be provided by storing the program in a magnetic disk, an optical disk, a semiconductor memory, or any other recording medium. The program can also be provided as a digitally encoded signal conveyed via a carrier wave. The described program can be a single program or can be implemented as multiple subprograms, each of which interact within a single computing device or interact in a distributed fashion across a network space.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram of a system that prioritizes and presents service offerings based upon a data driven context in accordance with an embodiment of the inventive arrangements disclosed herein.

FIG. 2 is a diagram illustrating the basic interaction flow of the components of a mobile device that prioritizes and presents service offerings based upon a data driven context in accordance with the inventive arrangements disclosed herein.

FIG. 3 is a graphical representation illustrating the user-specific contents of a profile for use in determining a situational context in accordance with an embodiment of the inventive arrangements disclosed herein.

FIG. 4 is a flow chart of a method detailing the actions taken by a system that prioritizes and presents service offerings based upon a data driven context in accordance with an embodiment of the inventive arrangements disclosed herein.

FIG. 5 is a graphical representation illustrating how the disclosed invention can operate in the case of a vehicle crisis in accordance with an embodiment of the inventive arrangements disclosed herein.

FIG. 6 is a graphical representation illustrating how the disclosed invention can operate to provide anticipatory shopping services in accordance with an embodiment of the inventive arrangements disclosed herein.

FIG. 7 is a graphical representation illustrating how the disclosed invention can operate to detect potential health issues and provide anticipatory services in accordance with an embodiment of the inventive arrangements disclosed herein.

### DETAILED DESCRIPTION OF THE INVENTION

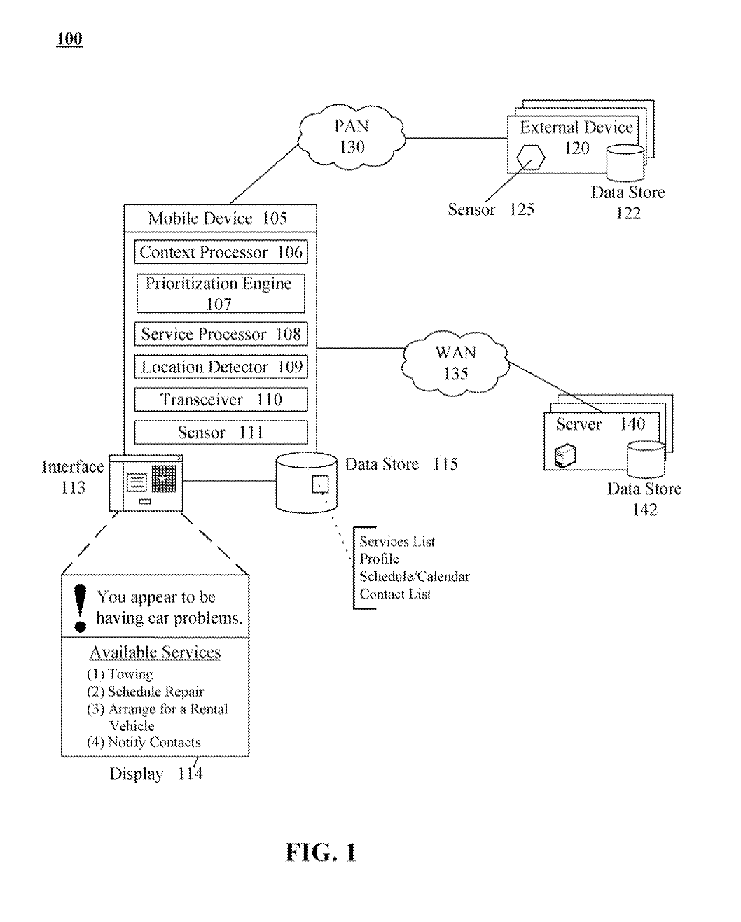

FIG. 1 is a schematic diagram of a system 100 that prioritizes and presents service offerings based upon a data driven context in accordance with an embodiment of the inventive arrangements disclosed herein. System 100 can include a mobile device 105 utilizing one or more transceivers 110 to communicatively link to an external device 120 via a Personal Area Network (PAN) 130 and a server 140 via a Wide Area Network (WAN) 135. This can allow the various components of the mobile device 105 to obtain a variety of situational data elements pertaining to the mobile device 105 and/or its user.

The mobile device 105 can utilize a variety of components in order to determine the situational context of the device 105 and present a user with a prioritized list of available services relevant to the situational context. These components can include a context processor 106, a prioritization engine 107, a service processor 108, a location detector 109, a transceiver 110, a sensor 111, an interface 113, and a data store 115.

The context processor 106 can execute software code that gathers situational data and determines the situational context. Situational data can be obtained from an external device 120, a server 140, data store 115, and other components of the mobile device 105, such as location detector 109 and sensor 111.

The external device 120 can be worn or carried by a user and can contain a sensor 125 and a data store 122. The sensor 125 can sense a variety of data regarding the circumstances of the user and/or the external device 120. For example, a BLUETOOTH headset can contain a sensor that monitors a wearer's heart rate and temperature. Data collected pertaining to the wearer's heart rate and temperature can be stored in the data store 122 and transmitted to the mobile device 105 over a PAN 130.

Additional situational data can be accessed over a WAN 135 from the data stores 142 on servers 140. This information can be tailored based on the device location. The device location can be determined by the location detector 109 component of the mobile device 105. The location detector 109 can be any of a variety of available components (e.g., a global positioning system (GPS) component) that can triangulate the location of an object utilizing signals received from mobile telephony towers. For example, the mobile device 105 can access a Web server that hosts phone book information to collect contact information for vehicle repair shops that are within a designated distance from the device's location.

The data store 115 that is local to the mobile device 105 can contain user-specific data such as a user profile containing user data and preferences, a calendar or schedule containing dates and/or events that are pertinent to the user, a list of contacts, and the like. Additionally, the local data store 115 can store data collected by the integrated sensor 111.

Once the context processor 106 determines the situation context from all the situational data, the prioritization engine 107 can prioritize the list of available services accordingly. For example, when a context of a vehicle problem is determined, the prioritization engine 107 can give more weight to services that are relevant to vehicle repair and replacement, such as towing and repair shop information, than standard services, such as Web browsing.

The prioritized list of services can be presented to the user of the mobile device 105 via an interface 113. The interface 113 can include a display 114 that alerts the user to the determined problem and displays the prioritized service list. A selection of one of the listed services in the interface 113 can invoke the services processor 108. The service processor 108 can execute software code to handle the service request generated by the user selection of a service. Handling the service request can entail the service processor 108 communicating with a server 140 to procure the selected service. Additionally, the service processor 108 can pass pertinent situational data, such as location and mobile telephone number, to the server 140, which alleviates the user's need to repeat or manually enter information.

As used herein, presented data stores, including stores 115, 122, and 142, can be a physical or virtual storage space configured to store digital information. Data stores 115, 122, and 142 can be physically implemented within any type of hardware including, but not limited to, a magnetic disk, an optical disk, a semiconductor memory, a digitally encoded plastic memory, a holographic memory, or any other recording medium. Each of the data stores 115, 122, and 142 can be a stand-alone storage unit as well as a storage unit formed from a plurality of physical devices. Additionally, information can be stored within data stores 115, 122, and 142 in a variety of manners. For example, information can be stored within a database structure or can be stored within one or more files of a file storage system, where each file may or may not be indexed for information searching purposes. Further, data stores 115, 122, and/or 142 can utilize one or more encryption mechanisms to protect stored information from unauthorized access.

Networks 130 and 135 can include any hardware/software/and firmware necessary to convey data encoded within carrier waves. Data can be contained within analog or digital signals and conveyed though data or voice channels. Networks 130 and 135 can include local components and data pathways necessary for communications to be exchanged among computing device components and between integrated device components and peripheral devices. Networks 130 and 135 can also include network equipment, such as routers, data lines, hubs, and intermediary servers which together form a data network, such as the Internet. Networks 130 and 135 can also include circuit-based communication components and mobile communication components, such as telephony switches, modems, cellular communication towers, and the like. Networks 130 and 135 can include line based and/or wireless communication pathways.

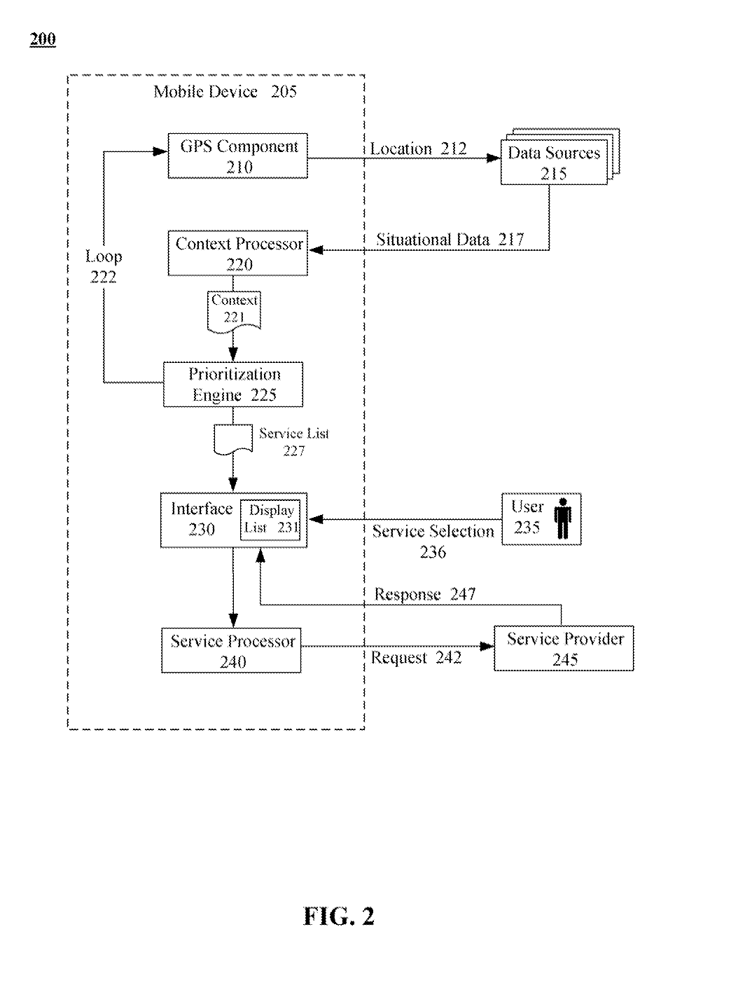

FIG. 2 is a diagram 200 illustrating the basic interaction flow of the components of a mobile device 205 that prioritizes and presents service offerings based upon a data driven context in accordance with the inventive arrangements disclosed herein. The illustrated interactions can occur in the context of system 100 or any other such system that supports prioritizing and presenting service offerings based upon a data driven context.

The interactions of diagram 200 can begin when a GPS component 210 of the mobile device 205 determines the device location and transmits the location 212 to external data sources 215. It should be noted that the GPS component 210 can be a specific implementation of the location detector 109 of system 100.

The various data sources 215 can return situational data 217 to the mobile device 205. Then, the context processor 220 can process the situational data 217 into a context 221 for the device 205. This context 221 can be passed to the prioritization engine 225. The prioritization engine 225 can use the context 221 as a basis by which to prioritize available services, producing a prioritized service list 227.

At this point, flow can proceed in two directions. The production of the prioritized list of services 227 can trigger an iteration of the previous steps, as indicated by the loop 222. Additional iterations of these steps can result in the collection of new or changed data, the determination of a new context, and the generation of a new prioritized list of services. Continual iterations can produce a prioritized list that dynamically changes as the user's situation changes.

While another iteration is conducted, the prioritization engine 225 can convey the prioritized service list 227 to the interface 230. The interface 230 can display the list 231 to a user 235. The user 235 can then make a service selection 236 via the interface 230. The interface 230 can invoke the service processor 240 to handle the service selection 236.

In handling the service selection 236, the service processor 240 can send a service request 242 to a service provider 245. The service provider 245 can then send a response 247 back to the mobile device 205. The response 247 can be displayed to the user 235 in the interface 230.

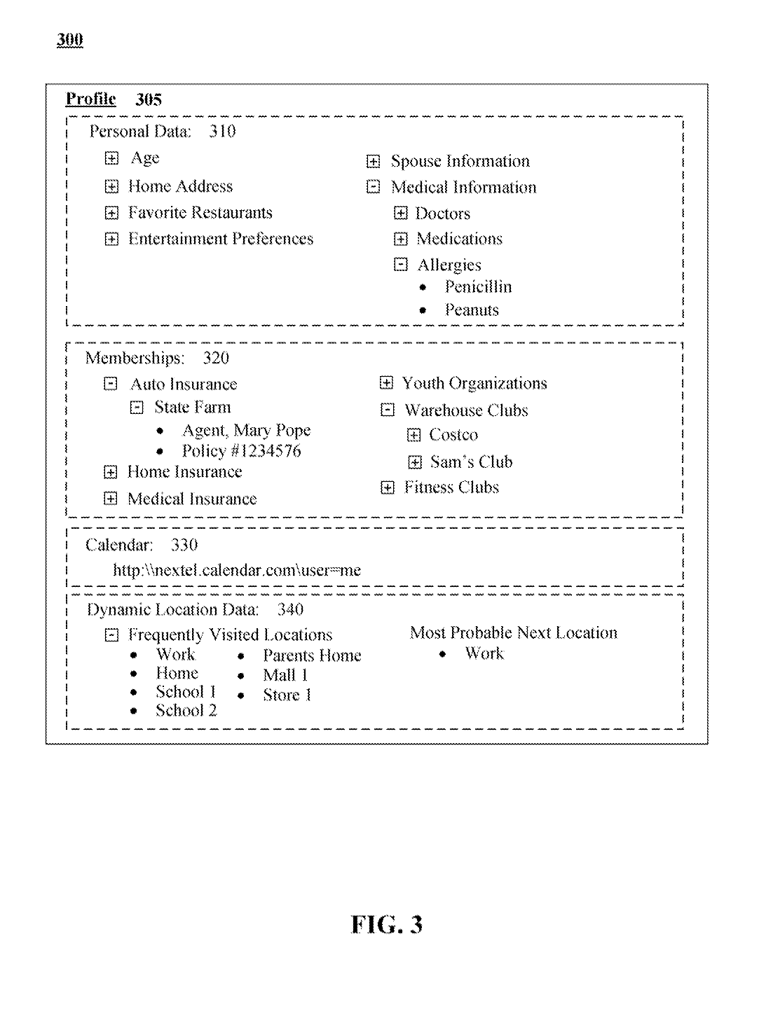

FIG. 3 is a graphical representation 300 illustrating the user-specific contents of a profile 305 for use in determining a situational context in accordance with an embodiment of the inventive arrangements disclosed herein. The data contained within the profile 305 can be stored within a data store local to the mobile device, as shown in system 100. It should be appreciated that the configuration and selection of data in this representation 300 is for illustrative purposes only, and should not be construed as a limitation of the invention.

The profile 305 can contain a quantity of data sections. In this example, the profile 305 contains sections for personal data 310, memberships 320, calendar 330, and location data 340. The personal data section 310 can include information pertaining to the owner or primary user of the mobile device, such as age and address, as well information pertaining to others, such as spouse information. Additional example data categories that can be included in this section are medical information, favored restaurants, and entertainment preferences.

The memberships section 320 can include data regarding the organizations to which the user belongs. As shown in this example, this can include insurance information, buyer programs, fitness clubs, and the like. The data related to these listings can include pertinent items such as organization contact information, policy numbers, and business locations.

The calendar section 330 can include user-entered information pertaining to scheduled appointments and upcoming events. Calendar section 330 information can be entered and stored locally to the mobile device via a local application, such as the scheduling function of a mobile phone. Alternately, the calendar section 330 can contain one or more external links, such as the one shown in this example, to access the location where such information is stored.

The profile 305 can also collect location data 340 to provide additional situational data for determining a situational context. For example, historical location data can be used to determine that the user is on their way to work when a vehicle problem occurs. Based on this information, the user can be presented with a service to notify work of the delay as well as the option to reschedule appointments.

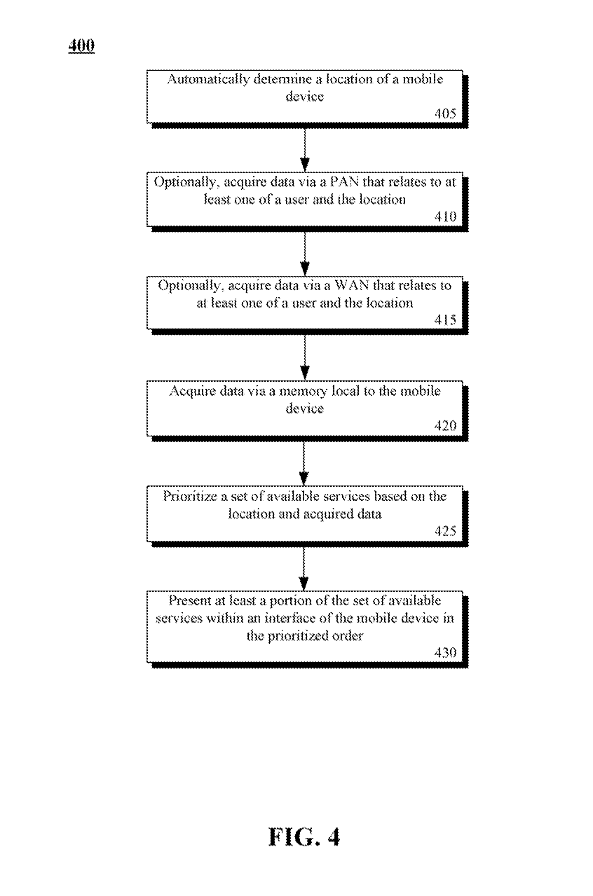

FIG. 4 is a flow chart of a method 400 detailing the actions taken by a system that prioritizes and presents service offerings based upon a data driven context in accordance with an embodiment of the inventive arrangements disclosed herein. Method 400 can be performed in the context of system 100 and/or utilizing the interactions of diagram 200.

Method 400 can begin with step 405 where the location of a mobile device can be automatically determined. Optionally, data relating to the device location and/or user can be acquired via a PAN in step 410. In step 415, data relating to the device location and/or user can be optionally acquired via a WAN.

Next, data contained in the local memory of the mobile device can be acquired in step 420. In step 425, a set of available services can be prioritized based upon the location and acquired data. At least a portion of the set of prioritized available services can be presented to the user in an interface of the mobile device in step 430.

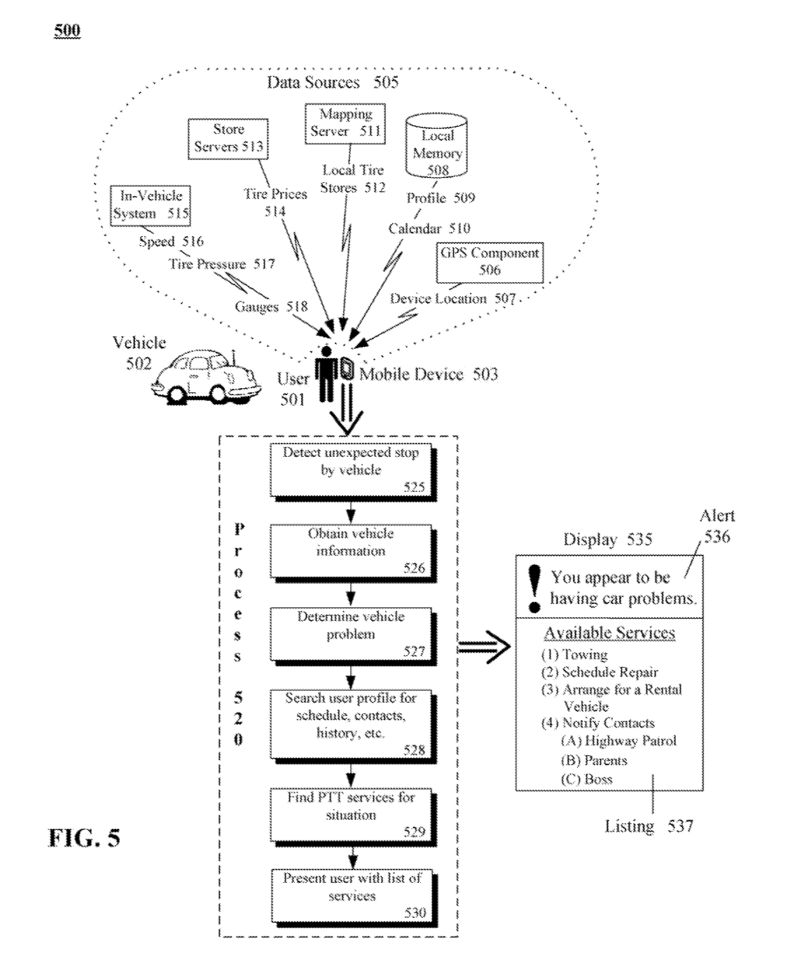

FIG. 5 is a graphical representation 500 illustrating how the disclosed invention can operate in the case of a vehicle crisis in accordance with an embodiment of the inventive arrangements disclosed herein. In this example, the vehicle 502 of user 501 has experienced a flat tire. The user's 501 mobile device 503 can represent an embodiment of the disclosed invention; a mobile device capable of prioritizing and presenting service offerings based on a data driven context.

The mobile device 503 can receive a multitude of data from a variety of internal and external data sources 505. Locally, the device 503 can receive the device location 507 determined by the GPS component 506, and the user's profile data 509 and calendar 510 from local memory 508.

The mobile device 503 can communicate with the in-vehicle system 515 of the vehicle 502 to obtain data regarding speed 516, tire pressure 517, and gauge data 518. Since data indicates that the vehicle 502 has a flat tire, related information can be gathered. A mapping server 511 can be queried with the device location to find local tire stores 512. Focal store servers 513 can be accessed to provide tire prices 514.

Process 520 outlines the steps that can occur during this situation. In step 525, the device 503 can detect an unexpected stop. Unexpectedness can he ascertained by historical data, time, and location. For example, the vehicle 502 is not stopped at a known intersection, has been stopped for more than the average traffic light cycle, and the user's calendar does not contain an entry for the stopped location.

Next, the device 503 can obtain information from the vehicle 502 in step 526. By analyzing the data, the system can determine the problem in step 527. For example, the tire pressure data 517 can indicate a fiat tire. Additional data sources 505 can be accessed to provide further situational context in step 528.

In step 529, the system can determine the push-to-talk (PTT) services that are available and relevant to the situation. A list of these services can be presented to the user 501 in step 530. Execution of step 530 can result in display 535.

Display 535 can include an alert 536 and a listing 537 of available services. As shown in this example, the listing 537 is prioritized according to the situation of a vehicle problem with services for towing and vehicle repair at the top of the list.

In another embodiment, the mobile device 503 can be configured to execute a designated action should the user 501 not select an option in a specified period. For example, if the user 501 is left unconscious after an accident, the device 503 can notify emergency services of the accident and the location after five minutes of unresponsiveness.

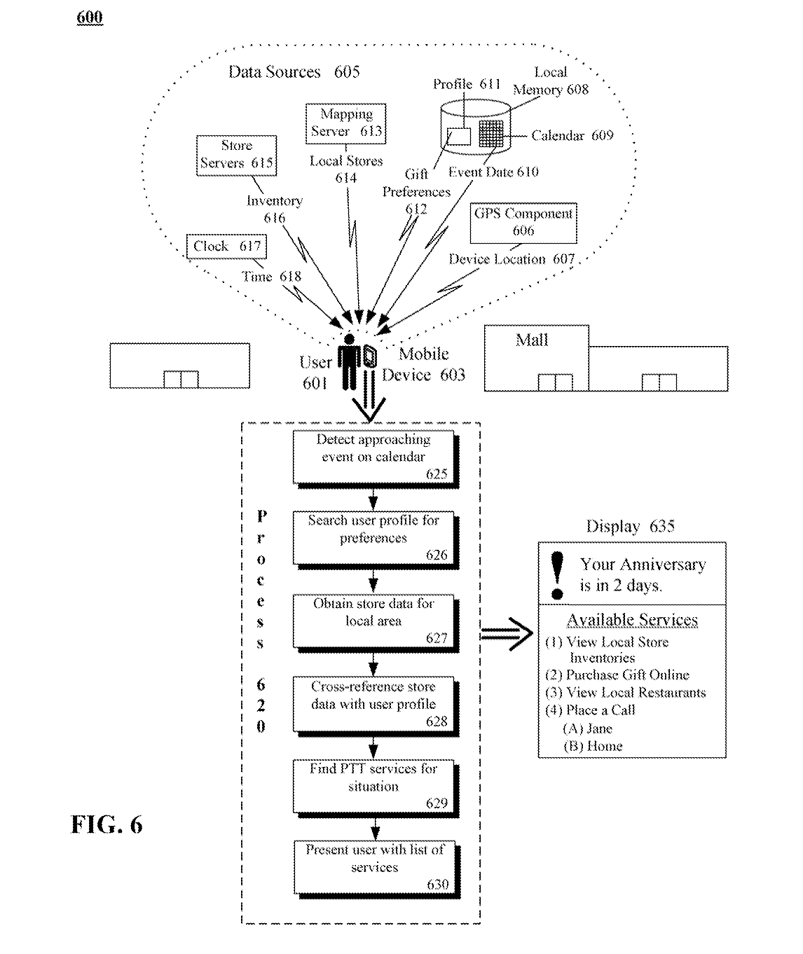

FIG. 6 is a graphical representation 600 illustrating how the disclosed invention can operate to provide anticipatory shopping services in accordance with an embodiment of the inventive arrangements disclosed herein. In this example, the user 601 is located at the local mall. Mobile device 603 can represent an embodiment of the disclosed invention; a mobile device capable of prioritizing and presenting service offerings based on a data driven context.

At noon, the user 601 accesses the list of services, expecting to receive a listing of restaurants in the area. However, the user 601 is presented with a display 635 containing an alert regarding an approaching anniversary and service options related to gift purchases at the forefront.

Process 620 can outline the details for the generation of the resultant display 635 using data gathered from various data sources 605. In step 625, the system can detect that an event date 610 is approaching since the user's 601 calendar 609 is located in the device's 603 local memory 608. Next, in step 626, the profile 611 data can be searched for entered gift preferences 612.

From the device location 607 determined by the GPS component 606, it can be ascertained that the user 601 is currently at the mall. A mapping server 613 can be queried for local stores 614 in step 627. The list of stores can be narrowed by obtaining the store inventory 616 from their servers 615 and only including those that match the gift preferences 612 in step 628.

In step 629, a list of applicable PTT services can be determined. The time 618 received from the clock 617 can indicate that it is lunchtime and, therefore, include local restaurants as a service. The user 601 can be presented with list of services in step 630, resulting in display 635.

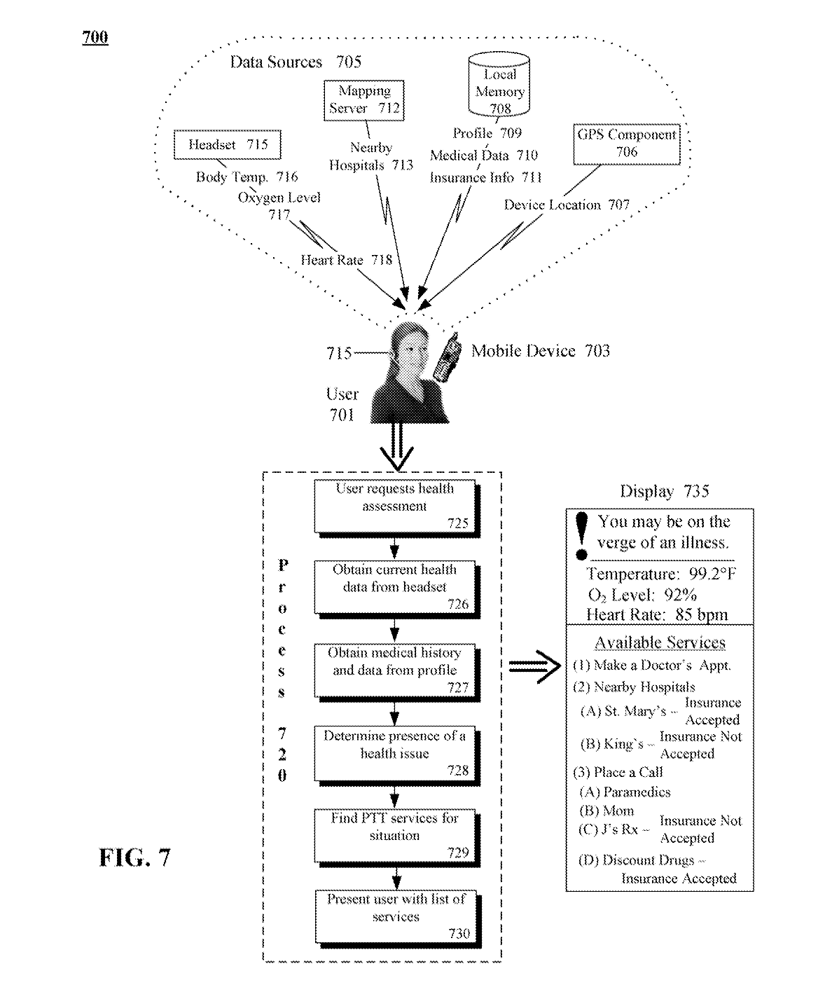

FIG. 7 is a graphical representation 700 illustrating how the disclosed invention can operate to detect potential health issues and provide anticipatory services in accordance with an embodiment of the inventive arrangements disclosed herein. In this example, the inventive system is represented by the mobile device 703 and headset 715.

In this example, the user 701 is feeling under the weather and uses the integrated sensors in her headset 715 in conjunction with her mobile device 703 to perform a health assessment. The user 701 is then presented with a display 735 containing an alert regarding the onset of a potential illness, vital sign data, and health-related service options.

Process 720 can detail the steps taken to generate the resultant display 735 using data gathered from various data sources 705. In step 725, the user can request a health assessment. This can trigger step 726 in which the mobile device 703 requests health-related data from the accompanying headset 715. The sensors within the headset 715 can measure the user's 701 body temperature 716, oxygen level 717, and heart rate 718.

In step 727, the system can access medical data 710 and insurance information 711 from the user's 701 profile 709 located in the local memory 708. By comparing the current vital sign data against historical data, the system can ascertain that the user 701 could be on the verge of an illness in step 728.

Related PTT services can be determined in step 729. For example, from the device location 707 determined by the GPS component 706, a list of nearby hospitals 713 can be requested from a mapping server 712. Further, entries in the available list of services can be noted for compliance with the user's 701 insurance information 711. In step 730, the user 701 can be presented with the list of services in a display 735.

The present invention may be realized in hardware, software, or a combination of hardware and software. The present invention may be realized in a centralized fashion in one computer system or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than to the foregoing specification, as indicating the scope of the invention.

What is claimed is:

1. A method for dynamically selecting user presented services based upon a context comprising:
a mobile communication device identifying situational data, said situational data including a location of the mobile communication device, a user profile, and at least one additional situational data element;
determining a situation context based upon the situational data;
automatically prioritizing a set of services based upon the situation context;
dynamically presenting at least a portion of the set of services in prioritized order upon an interface of the mobile communication device;
receiving a user selection of a presented service; and
performing at least one programmatic action responsive to the user selection, said at least one programmatic action contacting a service provider associated with the presented service.

2. The method of claim 1, wherein the situational data includes real-time data that is processed in real-time, and wherein the identifying, determining, prioritizing, and presenting steps are iteratively repeated as either the situational data changes or as a predetermined time passes.

3. The method of claim 1, further comprising:
determining that the situation context is associated with an emergency situation; and
automatically alerting a user of the mobile communication device of the emergency situation and automatically presenting the portion of the set of services.

4. The method of claim 1, further comprising:
automatically determining information related to the situational data relevant for the user selection; and
automatically conveying the determined information to the service provider.

5. The method of claim 1, wherein the situational data is obtained from a plurality of data sources, said data sources including an internal data store of the mobile communication device and at least one external data store.

6. The method of claim 5, wherein the at least one external data store includes at least one Personal Area Network (PAN) data store accessed using a PAN transceiver of the mobile communication device and at least one Wide Area Network (WAN) data store access using a WAN transceiver of the mobile communication device.

7. The method of claim 1, further comprising:
a sensor of a computing device external to a handset of the mobile communication device receiving input, the situational data including the received input.

8. The method of claim 1, wherein the situational data includes information automatically obtained from entries contained in a scheduling application of a user of the mobile communication device.

9. The method of claim 1, wherein the user profile comprises information selected from a group of information consisting of organizations to which the subscriber belongs, medical information for the subscriber, entertainment preferences of the subscriber, and eating preferences of the subscriber.

10. A mobile communication device comprising:
a location detection component configured to automatically determine a location of the mobile communication device;
at least one transceiver configured to permit the mobile communication device to exchange data with at least one remotely located data store;
a memory store comprising user-specific information;
a context processor configured to dynamically and automatically determine a situational context based upon the location determined by the location detection component information from the at least one remotely located data source, and the user-specific information;
a prioritization engine configured to automatically prioritize a set of available services based upon a context determined by the context processor;
a user interface configured to dynamically present prioritized ones of the services as determined by the prioritization engine for user selection; and
a service processor configured to handle user selected ones of the presented services.

11. A method for situationaly prioritizing services for display on a mobile device comprising;
automatically determining a location of the mobile device associated with a subscriber;
automatically acquiring data related to at least one of the subscriber and the location, wherein said data is acquired from a plurality of different data sources;
automatically prioritizing a set of available services, said prioritization being based upon the location and the acquired data;
presenting at least a portion of the set of available services within an interface of the mobile device in the prioritized order; and
iteratively repeating the determining, acquiring, prioritizing, and presenting steps, wherein the prioritized order dynamically changes as the location and the acquired data change.

12. The method of claim 11, wherein one of the different data sources is accessed via a personal area network communication channel and wherein another of the different data sources is a memory included within the mobile communication device.

13. The method of claim 12, wherein the personal area network is at least one of a BLUETOOTH connection aid a WIFI connection.

14. The method of claim 11, further comprising:
a sensor of a computing device external to the handset of the mobile telephony device receiving input, wherein the external computing device is one of the different data sources; and
conveying at least one of the information including the received input and information derived from the received input to the mobile communication device over the personal area network, wherein the acquired data includes the conveyed information.

15. The method of claim 14, wherein the sensor senses at least one condition selected from a group of conditions consisting of a physiological condition of the subscriber, an environmental temperature, a weather condition, and a condition of a vehicle within which the computing device is embedded.

16. The method of claim 12, wherein another one of the different data sources is accessed via a wide area network communication channel.

17. The method of claim 11, further comprising:
receiving information of a physiological condition of the subscriber using a sensor configured to monitor said physiological condition, wherein said acquired data includes the received information.

18. The method of claim 11, wherein one of the data sources is a calendar of the subscriber, which includes a plurality of scheduled events associated with the subscriber.

19. The method of claim 11, wherein one of the data sources is a profile containing information specific to the subscriber.

20. The method of claim 19, wherein the subscriber-specific information comprises information selected from a group of information consisting of organizations to which the subscriber belongs, medical information for the subscriber, entertainment preferences of the subscriber, and eating preferences of the subscriber.
